(19) United States
(12) Patent Application Publication
(10) Pub. No.: US 2021/0238905 A1
(43) Pub. Date: Aug. 5, 2021

(54) FINGER PROTECTION SECTION WITH INTEGRATED SWITCHING SYSTEM

(71) Applicant: Hübner GmbH & Co. KG, Kassel (DE)

(72) Inventors: Wjatscheslaw Pogorelow, Bad Wildungen (DE); Katharina Franck, Habichtswald (DE)

(21) Appl. No.: 17/160,045

(22) Filed: Jan. 27, 2021

(30) Foreign Application Priority Data
Jan. 28, 2020 (EP) 20154061.4

(51) Int. Cl. E05F 15/44; H01H 13/14; H01H 13/04

(52) U.S. Cl. CPC E05F 15/44; H01H 13/14; E05Y 2900/51; E05Y 2400/54; E05Y 2900/506; H01H 13/04

(57) ABSTRACT

An elastically resilient hollow section has an electrically operating switch rail that is fixedly integrated in a chamber of the hollow section. The switch rail has a jacket composed of an elastomer, and is actuable on a deformation of the hollow section. The switch rail projects freely from the hollow section at least one end of the hollow section.

### CROSS-REFERENCE TO RELATED APPLICATIONS

The present application is a continuation of and claims priority to European patent application EP 20154061.4, filed Jan. 28, 2020 and entitled “Elastically resilient hollow section having an electrically operating switch rail fixedly integrated in a chamber of the hollow section,” which is incorporated by reference herein in its entirety.

### FIELD OF THE INVENTION

The invention relates to an elastically resilient hollow section having a switch rail.

### BACKGROUND OF THE INVENTION

A hollow section of the initially named kind having a switch rail is also known under the term“finger guard section”. Such finger guard sections are used at doors of vehicles of public passenger transportation, for example of rail vehicles, but also of buses. The finger guard section typically substantially extends over the region of the door edge that is vertical in the installed state of the door and is connected to the door there by a frame section. This finger guard section provides that the switch rail is activated on a deformation of the hollow section, with the switch rail being connected to a control for a motor for opening and closing the door. The door is opened on an activation of the switch rail by a trapped object.

In this connection, a hollow section having a switch rail is known from the prior art in accordance with DE 10 2017 223 660 A1, wherein the switch rail has a hollow chamber that is manufactured from an elastomer and that serves the reception of two conductors that extend along the hollow chamber. The conductors arranged in the hollow chamber have a spacing from one another. The jacket of the hollow chamber is furthermore connected to the inner side of the hollow section by webs. Provision is made for the assembly of the hollow section to remove the webs over a certain portion of their lengths to set a termination component onto the respective end of the hollow section, wherein the termination component not only surrounds the jacket of the hollow chamber, but also projects into the space between the two conductors of the switch rail. The finger guard section is not sensitive or tactile in the region of this termination component.

A similar design of an elastically resilient hollow section is known from EP 2 629 312 A1. A termination component that can be pushed onto the jacket of the switch rail is also known here for the reception by the hollow section. The termination component is here not only placed onto the one front face end of the hollow section, but can also be placed, optionally provided with an end resistor, onto the other oppositely disposed end of the hollow section. It also applies here that the hollow section is not sensitive over its total length in the region of the termination components at the upper or lower end and consequently has portions in the upper and lower regions that cannot serve as anti-trap protection.

In this connection, a hollow section having an integrated switch rail arranged therein is known from DE 196 32 592 C1, wherein the deformable region of the hollow section is provided with chamfered end surfaces at both ends so that a trapezoidal design of the hollow section results over its length with respect to the deformable region of the hollow section. It is achieved by this trapezoidal design of the hollow section that if an application of force takes place in the region of the projecting end of the trapezoidal hollow section, the finger guard section is nevertheless activated since the force application is conducted into a portion of the switch rail disposed between the non-sensitive end regions.

It is, however, disadvantageous in this prior art that the switch rail cannot be reliably insulated against penetrating moisture due to the overhang of a part of the hollow section having the switch rail arranged in the hollow section because the switch rail is still located in the remaining overhanging hollow section.

### SUMMARY OF THE INVENTION

The underlying object of the invention accordingly comprises providing a hollow section as a finger protection rail that is actually sensitive over substantially its total length and furthermore permits a safe sealing of the switch rail.

It is proposed in accordance with the invention to achieve the object that the switch rail freely projects from the hollow section at at least one end, preferably at both ends, of the hollow section. This means that the jacket of an elastomer of the switch rail projects over a predeterminable portion from the hollow section; the switch rail can in particular project peripherally freely from the hollow section in the region of the projecting portion. This can be achieved in the assembly of the hollow section serving as a finger guard section in that the hollow section is cut out around the jacket of the switch rail and the switch rail is thus exposed.

The door of a vehicle for public passenger transportation mainly has a hollow section formed as a finger guard section only at the vertical closing edge of the door; frame sections that are typically not formed as finger guard sections, that is do not have any tactile region, are provided to seal frame sections at the other edges of the door. A termination section that is connected, e.g., adhesively bonded, to at least the front face of the hollow section can be provided in the respective region of the transition from the vertical closing edge to the horizontal closing edge. Alternatively, instead of the termination section, the frame section can directly adjoin the hollow section. The termination section or the frame section are formed the same as the hollow section at least with respect to the chamber for receiving the switch rail.

It has, however, been found that it is meaningful in the transition of the vertically aligned closing edge to the horizontal region of the door edge to provide a tactile region through the switch rail. Since a specific length of the switch rail projects from the hollow section formed as a finger guard section, there is now the option of pushing the projecting end of the switch rail into the termination section or the frame section or a switch rail chamber respectively provided therein. It is hereby achieved, as already stated, that the transition from the vertical region of the closing edge up to and into the horizontal edge of the door can also be formed as tactile. Even if no tight connection between the sections is achieved in the transition region from the hollow section to the termination or frame section, the sealing of the switch rail is not impaired hereby since the jacket of the switch rail extends continuously thereover and is in particular also not interrupted in the transition region.

Advantageous features and embodiments of the invention are also disclosed herein.

Provision is thus in particular made that the stranded wires of the switch rail are connected in the region of their projecting end to an end resistor to assemble the hollow section as a finger guard section.

Provision is furthermore in particular made in this connection that the live stranded wires are insulated in an at least moisture-proof manner in the region of the end resistor by an end piece connectable with material continuity to the jacket of the switch rail. This is, e.g., achieved by a plug that closes the jacket of the switch rail in the region of the live stranded wires and is either connected to the jacket of the switch rail that consists of an elastomer by way of vulcanization or is adhesively bonded thereto.

Provision is made in accordance with a further feature of the invention that the live stranded wires of the switch rail are provided with a connection cable in the region of its projecting ends, with the connection cable, e.g., being connected to the electric drive for the door. The live stranded wires of the switch rail are also insulated, preferably in an at least moisture-proof manner, in the region of their connection to the connection cable. This can take place by a cap by which the transition between the jacket of the switch rail, on the one hand, and the cables of the stranded wires, on the other hand, are insulated against penetrating moisture.

The hollow section is preferably formed integrally with the switch rail, i.e. the switch rail and the hollow section are formed as one component. A particularly advantageous and inexpensive manufacture of a hollow section having a switch rail comprising a jacket can take place by way of coextrusion. This means that the manufacture of the hollow section to form a finger guard section having a switch rail can be established in a two-component injection molding process.

The subject matter of the invention is likewise a method of manufacturing a finger guard section having an elastically resilient hollow section composed of an elastomer, having an electrically operating switch rail arranged in a chamber of the hollow section and comprising a jacket composed of an elastomer, wherein the manufacture of such a finger guard section comprises at least the following worksteps:
1. Coextruding the hollow section together with the switch rail;
2. Peripherally cutting free the jacket of the switch rail to form a first and/or second end of the switch rail projecting freely from the hollow section; and
3. Assembling the switch rail at the first and/or second end of the switch rail to form a finger guard section.

It becomes clear from this that the hollow section is cut free peripherally around the jacket of the switch rail over a certain portion of its length, preferably at both ends, after the coextrusion of the hollow section together with the j acket of the switch rail so that ultimately only the jacket of the switch rail projects from the hollow section at one or both ends of the hollow section. Subsequently to this, the switch rail is assembled with the projecting first and/or second ends to form the finger guard section. This means that the live stranded wires of the switch rail are advantageously exposed in the region of their first end for connection to an end resistor, with subsequently an insulation of the live stranded wires expediently taking place in the region of the end resistor by an end piece connected with material continuity to the jacket of the switch rail.

Provision can furthermore be made that the live stranded wires of the switch rail are connected to a connector cable in the region of its second end, with a moisture-proof insulation of the live stranded wires of the switch rail advantageously taking place by a cap in the region of their connection to the connector cable.

The subject matter of the invention is furthermore the use of an elastically resilient hollow section in accordance with the invention having an electrically operating switch rail arranged in a chamber of the hollow section, with provision being made in accordance with the invention that the arrangement of the hollow section takes place in a frame or frame portion of a door, in particular of a sliding door, to form a finger guard section. The door, in particular the sliding door, can here be part of a vehicle for public passenger transportation, e.g., part of a bus or of a rail vehicle.

The statements on the hollow section in accordance with the invention having the switch rail and on the method in accordance with the invention apply accordingly with respect to preferred embodiments of the use in accordance with the invention.

Advantageous further developments result from description and the drawings. The advantages named in the description of features and of combinations of a plurality of features are only exemplary and can come into effect alternatively or cumulatively without the advantages of embodiments in accordance with the invention necessarily having to be achieved. The features in the description are to be understood with respect to their number such that exactly this number or a larger number than said number is present without this requiring an explicit use of the term “at least”. If therefore, for example, a hollow chamber is spoken of, it is to be understood such that exactly one hollow chamber, two hollow chambers, or a plurality of hollow chambers is/are present. These features can be supplemented by other features or can be the only features the respective product consists of The reference numerals do not represent any restriction of the scope of the invention. They only serve the purpose of making the disclosure easier to understand.

### BRIEF DESCRIPTION OF THE DRAWINGS

Further measures improving the invention will be shown in more detail below together with the description of preferred embodiments of the invention with reference to the Figures. There is shown:

FIG. 1 is an isometric representation of a hollow section having a switch rail that is arranged in a chamber of the hollow section and that projects from the hollow section at both ends;

FIG. 2 is a cross-sectional view through the hollow section with the switch rail;

FIGS. 3a-3g are drawings showing worksteps for assembling a hollow section and of a switch rail at its first end to which stranded wires of the switch rail are connected by an end resistor;

FIGS. 4a-4g are drawings showing the second end of the switch rail, with here the stranded wires of the switch rail being connected to a cable for connection to a motor control; and

FIG. 5 is a schematic illustration of a door with a frame portion.

### DETAILED DESCRIPTION OF THE PREFERRED EMBODIMENTS

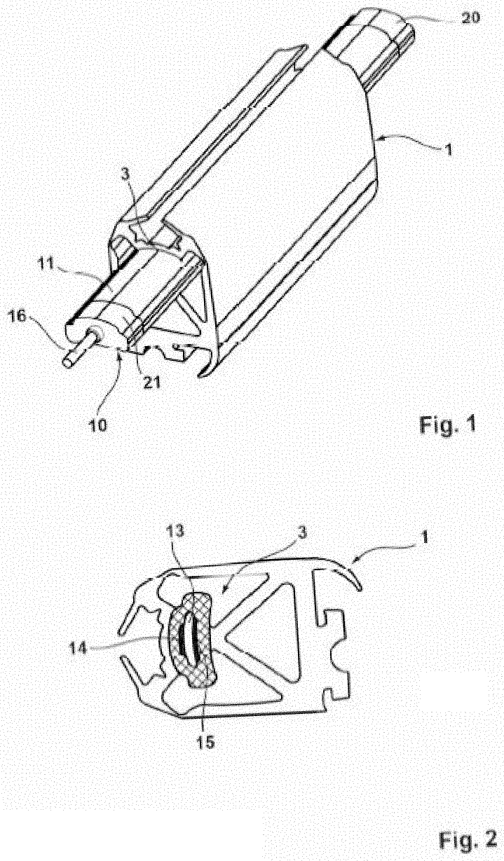

In accordance with FIG. 1, a switch rail 10 is received in a hollow section 1 or is integrally formed therewith, with the switch rail 10 extending through a chamber 3 of the hollow section 1 and freely projecting from the hollow section 1 at both ends thereof. The switch rail 10 has, as results from the sectional representation in accordance with FIG. 2, a jacket 11 composed of an elastomer, with a hollow space 13 being located in the jacket 11. Two electrically conductive contact cushions 14, 15 that each have a power stranded wire (not shown) that are spaced apart from one another in the hollow space 13. On contact of the two electrically conductive contact cushions, a signal to open the door is generated to the motor control.

Referring to all Figures, the switch rail 10 has an end piece 20 at its first end that terminates the open end of the jacket 11 of the switch rail 10 by the end resistor 17 in a moisture-proof manner. A connector cable 16 that is connected to the stranded wires in the contact cushions 14, 15, in the hollow space 13 is provided at the opposite second end of the switch rail 10. This cable 16 with the two stranded wires (not shown) is connected in a moisture-proof manner to the jacket 11 of the switch rail 10 by a cap 21.

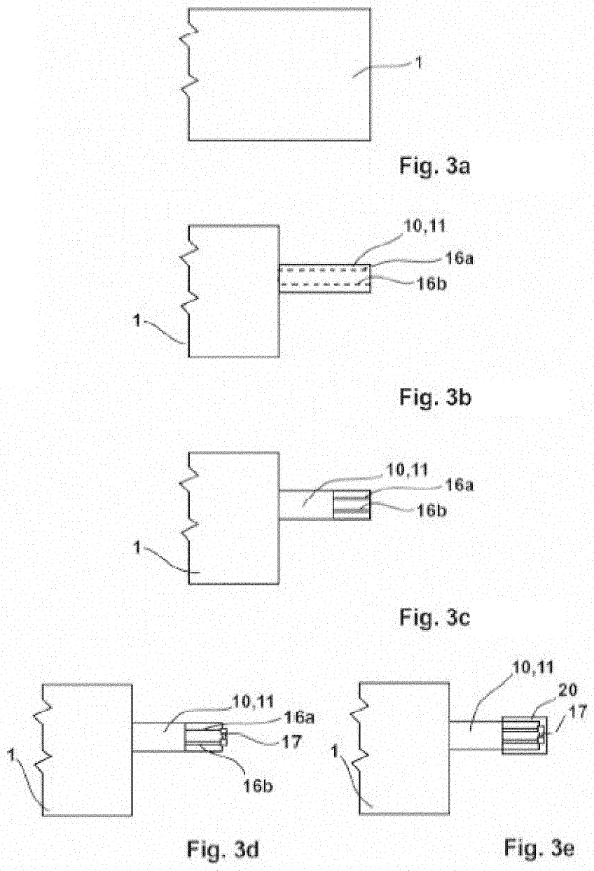

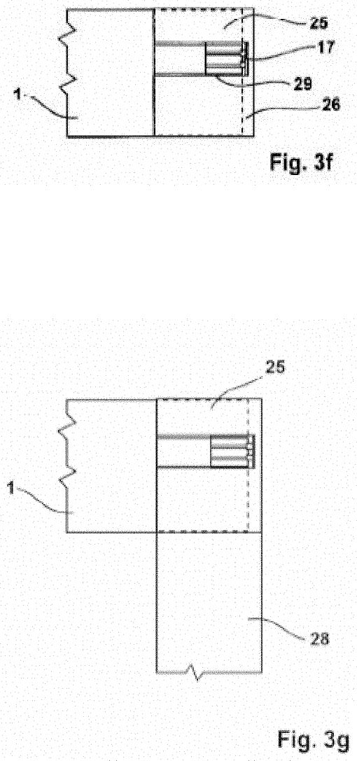

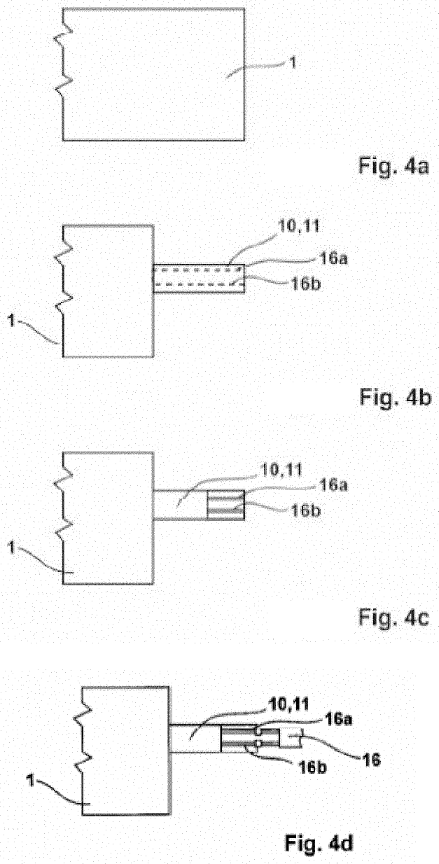

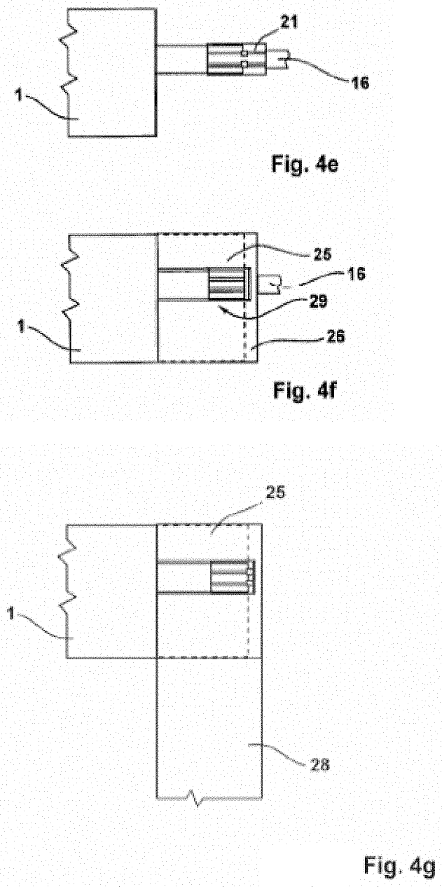

In accordance with FIGS. 3a, 4a the hollow section having the inwardly disposed switch rail (not shown) is designated by 1.

As results from FIGS. 3b, 4b, the hollow section 1 is cut away around the jacket 11 of the switch rail 10 in the end region of the switch rail 10 so that an overhang from the hollow section 1 results at its first end and at its second end.

FIGS. 3c and 4c show the exposure of the two stranded wires 16a, 16b of the switch rail 10, with the stranded wires 16a, 16b being connected to one another by an end resistor 17 in the region of the first end of the switch rail 10 (FIG. 3d).

As results from FIG. 4d, provision is made at the oppositely disposed second end of the switch rail 10 that the exposed stranded wires 16a, 16b of the switch rail 10 are connected to a cable 16. The cable 16 can in particular be connected to the motor control for the sliding door (not shown).

FIG. 3e in turn shows the region of the first end of the switch rail 10, with the two stranded wires 16a, 16b and the end resistor 17 being encapsulated in a moisture-proof manner by an end piece 20 that is connected in a moisture-proof manner to the jacket 11 of the switch rail 10.

It can be recognized from FIG. 4e that the two stranded wires 16a, 16b are insulated in a moisture-proof manner by a cap 21 that is connected in a moisture-proof manner to the jacket 11 of the switch rail 10 by way of vulcanization or by adhesive bonding.

FIG. 3f shows the hollow section 1 having a termination section 26 arranged at an end side thereat, with a cover 26 additionally being adhesively bonded, for example, to the termination section 25 to terminate the termination section 25 in a moisture-proof manner, said termination section 25 being able to be formed in a similar or in the same manner as the hollow section 1 in cross-section. As shown in FIG. 4f, just such a termination section 25 having just such a cover 26 is provided at the oppositely disposed end of the hollow section 1. The termination section 25 has a switch rail chamber 29 for receiving the end of the switch rail 10 projecting freely from the hollow section 1.

As results from FIGS. 3g and 4g, the termination section 25 can have a frame section 28 that can, e.g. be injected onto the termination section 25 having the cover 26 or can be adhesively bonded thereto. In this respect, the connector cable 16 can be conducted through the frame section 28 to the motor control (not shown).

Only the first end of the switch rail 10 is shown by way of example in FIGS. 3g; 4g.

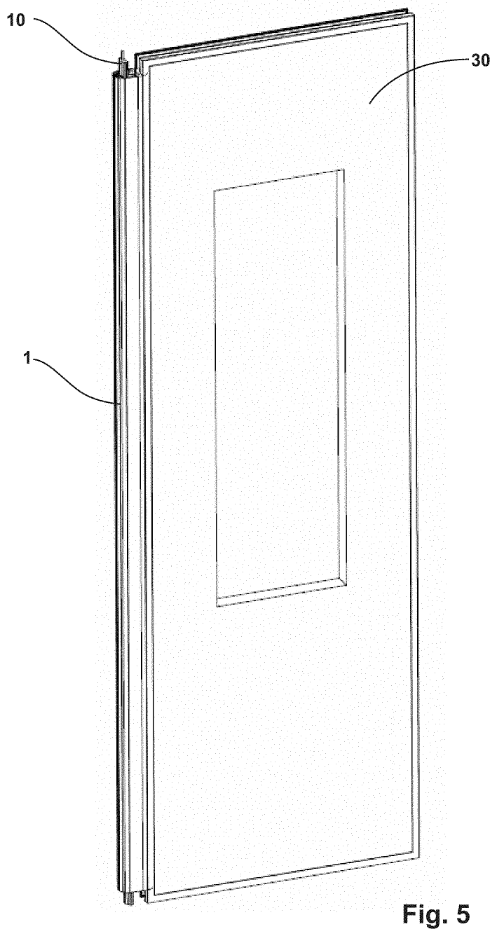

FIG. 5 schematically illustrates a door 30, which may be a sliding door such as for bus or rail vehicle. A hollow section 1 as described above may be disposed at the edge of the door 20 with the switch rail 10 projecting from at least one end of the hollow section.

### REFERENCE NUMERAL LIST

hollow section
chamber
switch rail
jacket
hollow space
contact cushion
contact cushion
connector cable
16a stranded wire
16b stranded wire
end resistor
end piece
cap
termination section
cover
frame section
switch rail chamber

What is claimed is:

1. An elastically resilient hollow section with an electrically operating switch rail, comprising:
an elastically resilient hollow section having a chamber defined therein; and
an electrically operating switch rail fixedly integrated in the chamber of the hollow section such that the switch rail is actuable on a deformation of the hollow section, the switch rail having a jacket composed of elastomer;
wherein the switch rail projects freely from at least one end of the hollow section.

2. The elastically resilient hollow section with the switch rail in accordance with claim 1, wherein:
the switch rail has a projecting end having live stranded wires;
further comprising an end resistor connected to the live stranded wires in a region of the projecting end.

3. The elastically resilient hollow section with the switch rail in accordance with claim 2, further comprising:
an end piece connectable with material continuity to the jacket of the switch rail;
wherein the live stranded wires are insulated in at least a moisture-proof manner in the region of the end resistor by the end piece.

4. The elastically resilient hollow section with the switch rail in accordance with claim 1, wherein:
the switch rail has a projecting end having live stranded wires;
further comprising a connector cable connected to the live stranded wires in a region of the projecting end.

5. The elastically resilient hollow section with the switch rail in accordance with claim 4, wherein the live stranded wires of the switch rail (10) are insulated in at least a moisture-proof manner in the region of their connection to the connector cable.

6. The elastically resilient hollow section with the switch rail in accordance with claim 1, further comprising a termination section for the hollow section disposed at first and/or second ends of the hollow section.

7. The elastically resilient hollow section with the switch rail in accordance with claim 6, wherein the termination section has a switch rail chamber into which the switch rail projects.

8. The elastically resilient hollow section with the switch rail in accordance with claim 1, wherein the hollow section is integrally formed with the switch rail having the jacket and is manufactured by coextrusion.

9. A method of manufacturing a finger guard section having an elastically resilient hollow section composed of an elastomer, having an electrically operating switch rail that is arranged in a chamber of the hollow section and that has a jacket composed of elastomer, the method comprising:
coextrusion of the hollow section together with the switch rail;
cutting free the jacket of the switch rail to form a first and/or second end of the switch rail projecting freely from the hollow section; and
assembling the switch rail at said first and/or second end of the switch rail to form the finger guard section.

10. The method in accordance with claim 9, further comprising exposing live stranded wires of the switch rail in a region of their first end for connection to an end resistor.

11. The method in accordance with claim 9, further comprising insulating the live stranded wires in the region of the end resistor by an end piece connectable with material continuity to the jacket of the switch rail.

12. The method in accordance with claim 9, further comprising connecting the live stranded wires of the switch rail to a connector cable in the region of its second end of the hollow section.

13. The method in accordance with claim 12, further comprising insulating the live stranded wires of the switch rail in a moisture-proof manner in the region of their connection to the connector cable.

14. A door assembly; comprising:
a door having an edge; and
an elastically resilient hollow section with an electrically operating switch rail disposed at the door edge to form a finger guard section, including;
an elastically resilient hollow section having a chamber defined therein; and
an electrically operating switch rail fixedly integrated in the chamber of the hollow section such that the switch rail is actuable on a deformation of the hollow section, the switch rail having a jacket composed of elastomer;
wherein the switch rail projects freely from at least one end of the hollow section.
